(19) United States
(12) Patent Application Publication
(10) Pub. No.: US 2026/0194859 A1
(43) Pub. Date: Jul. 9, 2026

(54) ESCAPEMENT MECHANISM OF A TIMEPIECE

(71) Applicant: Rolex SA, Genève 26 (CH)

(72) Inventors: Fabiano COLPO, Lausanne (CH); Olivier KARLEN, Blonay (CH); Xuan Mai TU, Ecublens (CH)

(21) Appl. No.: 19/440,392

(22) Filed: Jan. 5, 2026

(30) Foreign Application Priority Data
Jan. 9, 2025 (EP) 25151028.5

(51) Int. Cl. G04B 15/14

(52) U.S. Cl. CPC G04B 15/14

(57) ABSTRACT

An escapement device of a timepiece comprising: a first escapement mobile element, a second escapement mobile element engaged with the first escapement mobile element, a blocking mobile element arranged to cooperate with an oscillator of the timepiece, in which the first escapement mobile element comprises a first toothing comprising first blocking teeth, the second escapement mobile element comprises a second toothing comprising second blocking teeth, and in which the first escapement mobile element, the second escapement mobile element and the blocking mobile element cooperate together via the first blocking teeth and/or the second blocking teeth.

### CROSS-REFERENCE TO RELATED APPLICATIONS

The present application claims priority to European Application No. 25151028.5 filed with the European Patent Office on Jan. 9, 2025, which is incorporated herein by reference in its entirety for all purposes.

### TECHNICAL FIELD OF THE INVENTION

The present invention generally relates to an escapement device for a mechanical timepiece. Particularly, the present invention may relate to an escapement device comprising two escapement mobile elements. According to one aspect, the present invention may relate to an escapement device comprising escapement mobile elements provided to give impulses, particularly tangential impulses, to a blocking mobile element of the escapement device for a timepiece, particularly a mechanical timepiece.

### STATE OF THE ART

Escapement devices are known in the prior art to propose, as shown in the Application EP4198641A1, a natural escapement comprising two escapement wheels each provided to cooperate on the one hand with an articulated lever, and on the other hand with impulse pallets provided on the balance to ensure a direct cooperation with either of the two escapement wheels. However, such an escapement device is bulky and comprises a complex mechanism.

Document EP1367462A1 discloses a double indirect impulse escapement device, which comprises two escapement mobile elements meshing with each other and cooperating with a single rocker. During the rest phases, the rocker abuts on detent pins and the unblocking causes significant stresses and friction, which impairs the overall efficiency. Furthermore, it should be noted that in document EP1367462A1, a phase of releasing the rocker blocked in the rest position by one of the two escapement mobile elements, is followed by an impulse phase given by the other escapement mobile element to the rocker. Precise adjustments must therefore be provided to avoid any interference. Clearances are however necessary and require providing for angular paths of the rocker, and more generally parts of movement of the rocker, within which the rocker is without any contact with either of the two escapement mobile elements, once the latter is released. During these angular paths or parts of movement of the rocker, the latter therefore does not receive an impulse from either of the two escapement wheels, resulting in low efficiency.

Document EP1221637A1 relates to a double indirect impulse escapement device, which comprises two escapement mobile elements meshing with each other and cooperating with a single rocker. Each escapement wheel includes a large number of teeth, and the rocker is small in size, such that very precise manufacturing tolerances are necessary to guarantee the operation, and the rocker cannot transmit to the balance an impulse over a large angular travel. Particularly, the rocker has a specifically limited format compared to the respective format of the escapement wheels which are each equipped with a substantial number of teeth. As a result, the rocker has a very small size, making its manufacture complex, or the escapement wheels have a large size, which impairs the compactness of the system. Moreover, as well indicated in document EP1367462A1, the escapement in document EP1221637A1 does not allow obtaining a satisfactory impulse speed.

Document CH714200A1 discloses an escapement device which comprises two escapement mobile elements meshing with each other and cooperating with the same lever. During the impulse phases, the escapement mobile element giving the impulse pivots in the same direction as the lever, which causes friction and efficiency losses.

### DISCLOSURE OF THE INVENTION

One aim of the present invention is to address the drawbacks of the prior art mentioned above and particularly, firstly, to propose an escapement device that is simple to manufacture and/or assemble, and/or that has compact footprint and/or low-inertia pieces, and/or that has high operating efficiency, and/or that has improved shock and/or friction sensitivity, and/or a better compromise between these constraints.

To this end, a first aspect of the invention relates to an escapement device of a timepiece, comprising:
a first escapement mobile element arranged to be engaged with a drive gear train of the timepiece,
a second escapement mobile element engaged with the first escapement mobile element,
a blocking mobile element arranged to cooperate with an oscillator of the timepiece, in which:
the first escapement mobile element comprises a first toothing comprising first blocking teeth,
the second escapement mobile element comprises a second toothing comprising second blocking teeth,
the first escapement mobile element is arranged to block the blocking mobile element in a first rest position with one of the first blocking teeth of the first toothing during a first step called first-rest step, followed by a second step called first-impulse step,
the second escapement mobile element is arranged to block the blocking mobile element in a second rest position with one of the second blocking teeth of the second toothing during a third step called second-rest step, followed by a fourth step called second-impulse step,
   characterized in that:
during the second step called first-impulse step, the first escapement mobile element gives an impulse to the blocking mobile element, preferably with said one of the first blocking teeth, and drives directly one of the second blocking teeth of the second escapement mobile element with another of the first blocking teeth,
during the fourth step called second-impulse step, the second escapement mobile element gives an impulse to the blocking mobile element, preferably with said one of the second blocking teeth, and is driven directly via another of the second blocking teeth by one of the first blocking teeth of the first escapement mobile element.

According to the implementation above, the first and second escapement mobile elements cooperate together and each with the blocking mobile element via the same blocking teeth. In other words, the first toothing allows the first escapement mobile element to cooperate with the blocking mobile element and with the second escapement mobile element, while the second toothing allows the second escapement mobile element to cooperate with the blocking mobile element and with the first escapement mobile element. Only one type of teeth (the first blocking teeth) ensures the contacts of the first escapement mobile element with the blocking mobile element and with the second escapement mobile element, only one type of teeth (the second blocking teeth) ensures the contacts of the second escapement mobile element with the blocking mobile element and with the first escapement mobile element. The structure of the first and second escapement mobile elements can thus be simplified, their inertia can thus be reduced and their dimensions can be provided to reduce as much as possible the space requirement required in the escapement device.

According to an embodiment, the oscillator comprises an inertial element (typically a balance) that has an oscillatory movement, and each oscillation comprises a first vibration (during which the balance pivots or moves along a first direction of rotation or of displacement) and a second vibration (during which the balance pivots or moves along a second direction of rotation or of displacement).

According to an embodiment, the first step called first-rest step is followed by the second step called first-impulse step during a first vibration of an oscillation, and the third step called second-rest step is followed by the fourth step called second-impulse step during a second vibration of said oscillation.

The escapement device can be defined according to the following characteristics, taken individually or in combination.

According to an embodiment, the first escapement mobile element drives the second escapement mobile element exclusively with the first blocking teeth of the first toothing.

According to an embodiment, the second escapement mobile element is driven by the first escapement mobile element exclusively with the second blocking teeth of the second toothing.

According to an embodiment, the first escapement mobile element and/or the second escapement mobile element comprises or consists of a planar toothed wheel, preferably identical. According to an embodiment, each planar toothed wheel includes only one type of teeth. According to an embodiment, the first escapement mobile element and the second escapement mobile element are formed by, or comprise, identical toothed wheels, one being mounted inverted (or in reverse) relative to the other. A same escapement wheel can thus be typically provided, with a single toothing, or a single type of teeth.

According to an embodiment:
during the second step called first-impulse step, the first escapement mobile element gives an impulse to the blocking mobile element with said one of the first blocking teeth (the one that was in contact with the blocking mobile element during the first step called first-rest step), and drives directly one of the second blocking teeth of the second escapement mobile element with another of the first blocking teeth, which is adjacent to said first blocking teeth,
during the fourth step called second-impulse step, the second escapement mobile element gives an impulse to the blocking mobile element with said one of the second blocking teeth (the one that was in contact with the blocking mobile element during the third step called second-rest step), and is driven directly via another of the second blocking teeth, which is adjacent to said one of the second blocking tooth. Thus, during a single vibration of the oscillator, on each escapement mobile element, different (but adjacent) blocking teeth cooperate with the blocking mobile element on the one hand, and with the other of the escapement mobile elements on the other hand. These characteristics allow dissociating the interaction functions with the blocking mobile element on the one hand, and with the other of the escapement mobile elements on the other hand to design the shape of the blocking teeth with greater freedom, while maintaining a compact escapement device. Combined with an embodiment in which the first escapement mobile element comprises between four and eight teeth, preferably six teeth, and/or the second escapement mobile element comprises between four and eight teeth, preferably six teeth, only one tooth (said adjacent tooth) drives the other escapement mobile element, which reduces the design difficulties related to the management of the hyperstatism and the clearances necessary to avoid it. In other words, during an impulse phase given by an escapement mobile element, the latter cooperates with the blocking mobile element at a single point of contact and the other escapement mobile element at a single point of contact.

According to an embodiment:
each first blocking tooth comprises, from a tooth root, a first concave portion, a second convex portion and a distal surface,
each second blocking tooth comprises, from a tooth root, a first concave portion, a second convex portion, and a distal surface,
   and:
each distal surface of the first escapement mobile element and of the second escapement mobile element is arranged to be in contact with and block the blocking mobile element, during the first step called first-rest step or during the third step called second-rest step,
each second convex portion of the first escapement mobile element is arranged to be in contact with and drive a second convex portion of the second escapement mobile element, during the second step called first-impulse step or during the fourth step called second-impulse step,
each first concave portion of the first escapement mobile element and of the second escapement mobile element is arranged to have a positive clearance or an absence of contact with each distal surface or with each second convex portion of the second escapement mobile element and of the first escapement mobile element, respectively. Thus, each blocking tooth of an escapement mobile element comprises an area dedicated to the cooperation with the blocking mobile element (the distal surface), an area dedicated to the cooperation with the other escapement mobile element (the convex portion), and an area dedicated to receiving the distal surface of the blocking teeth of the other escapement mobile element (the concave portion) to prevent any interference.

According to an embodiment:
each first concave portion has a first tooth thickness E1,
each second convex portion has a second tooth thickness E2,
   and:

### 1.5.E1<E2<2.5.E1

According to an embodiment:
each distal surface of the first escapement mobile element and of the second escapement mobile element is formed by one end of each first blocking tooth and of each second blocking tooth, and/or,
each distal surface of the first escapement mobile element and of the second escapement mobile element is formed by a rounded surface constituting a tooth tip, and/or
each distal surface of the first escapement mobile element and of the second escapement mobile element is arranged to cooperate exclusively with the blocking mobile element.

According to an embodiment:
each distal surface of the first escapement mobile element and of the second escapement mobile element is arranged to cooperate, preferably exclusively, with the blocking escapement mobile element and with the second escapement mobile element or the first escapement mobile element, respectively.

According to an embodiment:
each first blocking tooth comprises a first-tooth end,
each second blocking tooth comprises a second-tooth end.
   and each first-tooth end and each second-tooth end comprises a first tooth flank surface and a second tooth flank surface, adjacent and each having respectively at least a first tangent direction and at least a second tangent direction forming together a salient angle Δ (viewed from the axis of rotation of the escapement mobile element in question). According to this embodiment, each blocking tooth comprises at its end a first tooth flank surface and a second tooth flank surface forming together a salient angle Δ and thus providing two distinct functional surfaces which may lead to further reducing the unblocking effort provided by the balance to unblock either of the escapement mobile elements.

In general and according to an embodiment, the blocking mobile element comprises:
a first impulse input surface and a second impulse input surface,
a first blocking surface portion and a second blocking surface portion, and the first impulse input surface and the second impulse input surface are each arranged between the first blocking surface portion and the second blocking surface portion. In other words, we can define on the blocking mobile element:
a blocking sector angle defined by two straight lines each passing through the center of rotation of the blocking mobile element and intersecting respectively the first blocking surface portion and the second blocking surface portion,
an impulse sector angle defined by two straight lines each passing through the center of rotation of the blocking mobile element and tangent respectively to the first impulse input surface and to the second impulse input surface (or passing through these first and second impulse input surfaces),
   and the blocking sector angle is strictly greater than the impulse sector angle. According to an embodiment, each escapement wheel is arranged to exert on the blocking mobile element an impulse effort directed outwards from the blocking mobile element or opposite to a plane of symmetry of the blocking mobile element. According to this implementation, as opposed to that of document EP1221637A1, the blocking mobile element has a single central recess delimited by the first impulse input surface and by the second impulse input surface, such that the structure is simplified while offering a transmission of the impulses over a large angular stroke.

According to an embodiment, the blocking mobile element comprises:
a first impulse input surface and a second impulse input surface,
a first blocking surface portion and a first blocking beak, preferably separated by a first recess, the first blocking beak being arranged between the first blocking surface portion and the first impulse input surface,
a second blocking surface portion and a second blocking beak, preferably separated by a second recess, the second blocking beak being arranged between the second blocking surface portion and the second impulse input surface,
so that during the first step called first-rest step, a second tooth flank surface of the first escapement mobile element is bearing on the first blocking surface portion and/or on the first blocking beak of the blocking mobile element, and so that during the third step called second-rest step, a second tooth flank surface of the second escapement mobile element is bearing on the second blocking surface portion and/or on the second blocking beak of the blocking mobile element,
and so that during the second step called first-impulse step, a first tooth flank surface of the first escapement mobile element is in contact with the first impulse input surface, and so that during the fourth step called second-impulse step, a first tooth flank surface of the second escapement mobile element is in contact with the second impulse input surface. According to this embodiment, each blocking tooth in contact with the blocking mobile element during the rest phase can bear on the blocking mobile element on two distinct portions (the respective blocking surface portion and/or the blocking beak), which contributes to providing a stable rest position. According to this embodiment, the first blocking surface portion and the first blocking beak, as well as the second blocking surface portion and the second blocking beak, can be separated by a recess, which reduces the risks of hyperstatism, butting or instability. Also according to this embodiment, the second tooth flank surface and the first tooth flank surface provided at the end of each blocking tooth of the first and second escapement mobile elements are alternately or successively in contact with the blocking mobile element during the transition from the rest step to the immediately following impulse step, which allows reducing the unblocking force necessary to the oscillator (typically the hairspring-balance) to unblock the escapement device.

According to an embodiment, the blocking mobile element is pivotally mounted and presents, between the first rest position and the second rest position, a rocking angle comprised between 50° and 70°, preferably between 55° and 65°, preferably between 57° and 63°. Such a rocking angle is much larger than that of an anchor in a Swiss lever escapement, thus providing a much larger angular path during which the first or the second escapement mobile element can give the impulse, which maximizes the work provided by the first or the second escapement mobile element.

According to an embodiment, the first escapement mobile element comprises between four and eight teeth, preferably six teeth, and/or the second escapement mobile element comprises between four and eight teeth, preferably six teeth. Such a limited number of teeth allows for a specifically compact construction, which is an important criterion, particularly within the framework of an escapement with two active vibrations and tangential drive.

Another aspect of the invention relates to a timepiece comprising at least one escapement device according to the first aspect

### DESCRIPTION OF THE FIGURES

Other characteristics and advantages of the present invention will become more apparent upon reading the following detailed description of embodiment(s) of the invention given by way of non-limiting example(s) and illustrated by the appended drawings, in which:

FIG. 1 represents an escapement device comprising a first and a second escapement mobile element, a blocking mobile element and a balance plate of an oscillator of a timepiece, the escapement device being represented in FIG. 1 during a first step called first-rest step in which the blocking mobile element is in a first rest position, in order to be in contact with and block the first escapement mobile element;

FIG. 2 represents the escapement device of FIG. 1, during a first intermediate unblocking step that immediately follows the first step called first-rest step;

FIG. 3 represents the escapement device of FIG. 1, at the beginning of a second step called first-impulse step, in which the first escapement mobile element is in contact with the blocking mobile element to give it an impulse;

FIG. 4 represents the escapement device of FIG. 1, during the second step called first-impulse step;

FIG. 5 represents the escapement device of FIG. 1, at the end of the second step called first-impulse step;

FIG. 6 represents the escapement device of FIG. 1, during a third step called second-rest step, in which the blocking mobile element is in a second rest position, in order to be in contact and block the second escapement mobile element;

FIG. 7 represents the escapement device of FIG. 1, during a second intermediate unblocking step that immediately follows the third step called second-rest step;

FIG. 8 represents the escapement device of FIG. 1, at the beginning of a fourth step called second-impulse step, in which the second escapement mobile element is in contact with the blocking mobile element to give it an impulse;

FIG. 9 represents the escapement device of FIG. 1, during the fourth step called second-impulse step;

FIG. 10 represents the escapement device of FIG. 1, at the end of the fourth step called second-impulse step;

FIG. 11 represents the first rest position and the second rest position that the blocking mobile element can occupy;

FIGS. 12a and 12b represent in detail the blocking mobile element of the escapement device of FIG. 1;

FIG. 13 represents an escapement wheel forming part of the first or the second escapement mobile element of the escapement device of FIG. 1

FIG. 14 represents in detail a blocking tooth of the escapement wheel of FIG. 13;

FIG. 15 represents in detail a tip of a blocking tooth of the escapement wheel of FIG. 13;

FIG. 16 represents one variant of embodiment of the escapement wheel of FIG. 13;

FIG. 17 represents in detail a blocking tooth of the escapement wheel of FIG. 16;

FIG. 18 represents in detail a tip of a blocking tooth of the escapement wheel of FIG. 16;

FIGS. 19a and 19b represent in detail one variant of embodiment of the blocking mobile element of FIGS. 12a and 12b;

FIGS. 20a and 20b represent respectively a general view and a detailed view of one variant of embodiment of the escapement device of FIG. 1, comprising in particular a first and a second blocking mobile element comprising the escapement wheel of FIG. 16, and the blocking mobile element of FIGS. 19a, 19b in a first rest position occupied during a first step called first-rest step, in which the blocking mobile element is in contact with and blocks the first escapement mobile element;

FIGS. 21a and 21b represent respectively a general view and a detailed view of the escapement device of FIG. 20a, during a first intermediate unblocking step which immediately follows the first step called first-rest step.

FIGS. 22a and 22b represent respectively a general view and a detailed view of the escapement device of FIG. 20a, at a first instant of a second step called first-impulse step, in which the first escapement mobile element is in contact with the blocking mobile element to give it an impulse;

FIGS. 23a and 23b represent respectively a general view and a detailed view of the escapement device of FIG. 20a, at a second instant of the second step called first-impulse step;

FIGS. 24a and 24b represent respectively a general view and a detailed view of the escapement device of FIG. 20a, at a third instant of the second step called first-impulse step;

FIGS. 25a and 25b represent respectively a general view and a detailed view of the escapement device of FIG. 20a, at the end of the second step called first-impulse step;

FIGS. 26a and 26b represent respectively a general view and a detailed view of the escapement device of FIG. 20a, during a third step called second-rest step, in which the blocking mobile element is in a second rest position, in order to be in contact and block the second escapement mobile element.

### DETAILED DESCRIPTION OF EMBODIMENT(S)

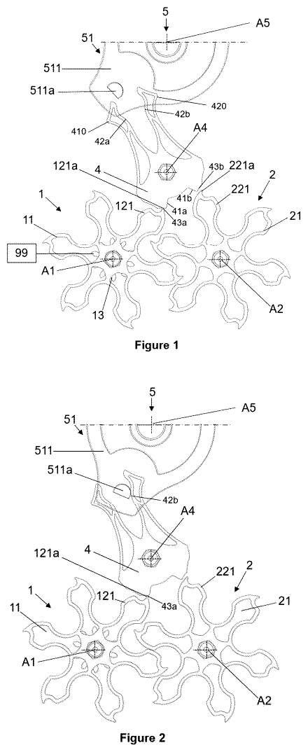

FIG. 1 represents an escapement device of a timepiece, comprising:
a first escapement mobile element 1 arranged to be engaged with a drive gear train 99 of the timepiece,
a second escapement mobile element 2 engaged with the first escapement mobile element 1,
a blocking mobile element 4 arranged to cooperate with an oscillator 5 of the timepiece.

In detail, the first escapement mobile element 1:
is movable in rotation about a first axis of rotation A1,
comprises a first escapement wheel 11 and a pinion 13, typically both driven onto a first shaft defining the first axis of rotation A1,
is engaged with a drive gear train 99 via the pinion 13 to be driven in rotation,
comprises a first toothing comprising first blocking teeth 121 each having a distal surface 121a.

The second escapement mobile element 2, for its part:
is movable about a second axis of rotation A2,
comprises a second escapement wheel 21 typically driven onto a second shaft defining the second axis of rotation A2,
comprises a second toothing comprising second blocking teeth 221, each having a distal surface 221a,
is engaged, via the second blocking teeth 221, with the first blocking teeth 121 of the first escapement mobile element 1 to be driven in rotation.

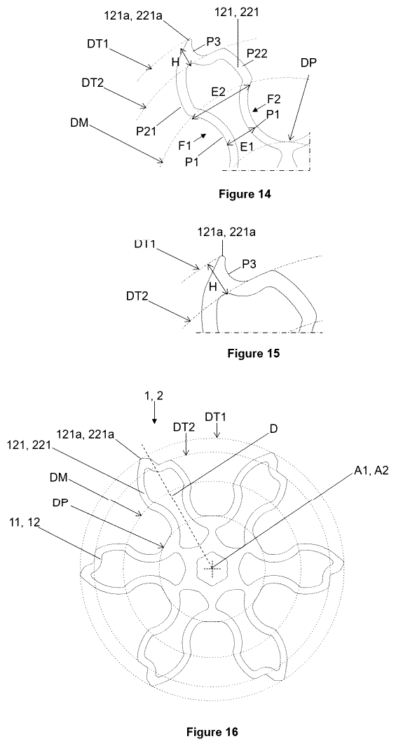

It can be noted in FIG. 1 that the first escapement wheel 11 and the second escapement wheel 21 are identical and simply mounted in reverse. FIGS. 13 to 15 show in more detail the structure of the first escapement wheel 11 and of the second escapement wheel 21.

Particularly, the first escapement wheel 11 and the second escapement wheel 21 are each preferably equipped with six blocking teeth 121, 221. More generally, this number of blocking teeth 121, 221 can be comprised between four and eight. It may be noted that the small number of blocking teeth 121, 221 could lead to qualify the first escapement wheel 11 and the second escapement wheel 21 as pinions, the Berner dictionary qualifying a pinion as a toothed member that generally has from 6 to 14 teeth or leaves.

The blocking teeth 121, 221 are adjoined, that is to say only a gap separates two successive or consecutive blocking teeth 121, 221 of the first escapement wheel 11 and of the second escapement wheel 21.

Preferably, the first escapement wheel 11 and the second escapement wheel 21 are identical and are simply assembled differently on their respective axis along opposite orientations. Preferably, all the blocking teeth 121, 221, particularly all the distal surfaces 121a, 221a, are identical.

A characteristic can be noted concerning the first escapement wheel 11 and the second escapement wheel 21 which relates to the fact that the flanks F1, F2 of each of the blocking teeth 121, 221 are respectively equipped with a first concave portion P1 (viewed from outside the tooth considered) having a thickness E1, and with a second convex portion P21, P22 (viewed from outside the tooth considered) having a thickness E2. This characteristic allows obtaining a small number of blocking teeth 121, 221 of the first escapement wheel 11 and of the second escapement wheel 21.

Particularly, the first portion P1 is inscribed or substantially inscribed between a root diameter DP and a mean diameter DM whose value corresponds to the average of the respective values of the root diameter DP and of a first head diameter DT1 through which the distal surfaces 121a, 221a pass (DM=(DP+DT1)/2).

In this case, each distal surface 121a, 221a corresponds, in this embodiment illustrated in FIGS. 1 to 15, to a rounded surface that constitutes the tip of a blocking tooth 121, 221 (the rounded surface being more specifically visible in FIG. 15). Particularly, each distal surface 121a, 221a constitutes the rounded end of a distal portion P3. Thus, it is possible to draw a circle of diameter DT1 that is tangent to one or to all surfaces 121a, 221a.

The second portion P21 of the flank F1 is inscribed or substantially inscribed between the mean diameter DM and the head diameter DT1 and thus comprises the distal portion P3, while the second portion P22 of the flank F2 is inscribed or substantially inscribed between the mean diameter DM and a second head diameter DT2.

The second head diameter DT2 is a function of the height H of the distal portion P3, which comprises the distal surface 121a, 221a, with H=(DT1−DT2)/2.

The thickness E of each of the blocking teeth 121, 221, that is to say the distance separating the two flanks F1, F2 along a direction orthoradial to the axis A1, A2, has a maximum value E2 at the diameter DM or substantially at the diameter DM, that is to say where the derivative changes sign (that is to say there is a turning point or a local extremum), or where the direction of the slope changes going from the first portion P1 to the second portion P21, P22. The thickness E of each of the blocking teeth 121, 221 has a minimum value E1 at the first portion P1. It can be noted that 1.5.E1<E2<2.5.E1.

Preferably, the portions P1 are arcs of circles. Preferably, the portions P21, P22 are arcs of circles.

Preferably, the first portions P1 of two adjoined teeth are inscribed within the same arc of circle C1 (see FIG. 13).

In the construction represented in FIGS. 13 to 15, it can be noted that DP~0.35.DT1. More generally, DP≤0.5.DT1, or even DP≤0.4.DT1.

In the escapement device illustrated in FIGS. 1 to 10, the distal surfaces 121a, 221a cooperate exclusively with the functional areas 41a, 41b, 43a, 43b of the blocking mobile element 4 for the implementation of the respective rest, unlocking or unblocking and impulse steps. In other words, these distal surfaces 121a, 221a do not play a role in allowing the meshing of the toothed members 11, 21; that is to say they do not cooperate with the portions P1, P21, P22.

FIG. 1 further shows that the blocking mobile element 4:
is movable in rotation about a third axis of rotation A4,
comprises first blocking means in the form of a first blocking surface portion 43a to block the first escapement mobile element 1,
comprises second blocking means in the form of a second blocking surface portion 43b to block the second escapement mobile element 2,
comprises first impulse input means in the form of a first impulse input portion 41a to receive an impulse from the first escapement mobile element 1,
comprises second impulse input means in the form of a second impulse input portion 41b to receive an impulse from the second escapement mobile element 2,
comprises a fork with a first horn 410 and a second horn 420, the first horn 410 comprising a first impulse surface or portion 42a, the second horn 420 comprising a second impulse surface or portion 42b,
has a plane of symmetry passing through the third axis of rotation A4.

The oscillator 5 comprises a balance 51 movable in rotation about a fourth axis of rotation A5 and which comprises a balance plate 511 equipped with a pin 511a that can cooperate with the fork of the blocking mobile element 4. The oscillator 5 also comprises an elastic return member, typically a hairspring, coupled to the balance 51.

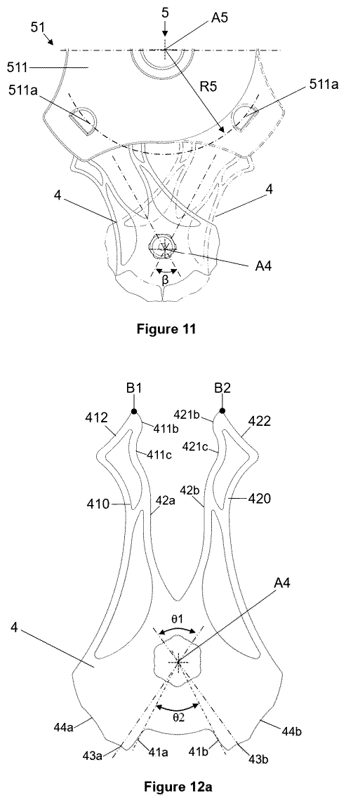

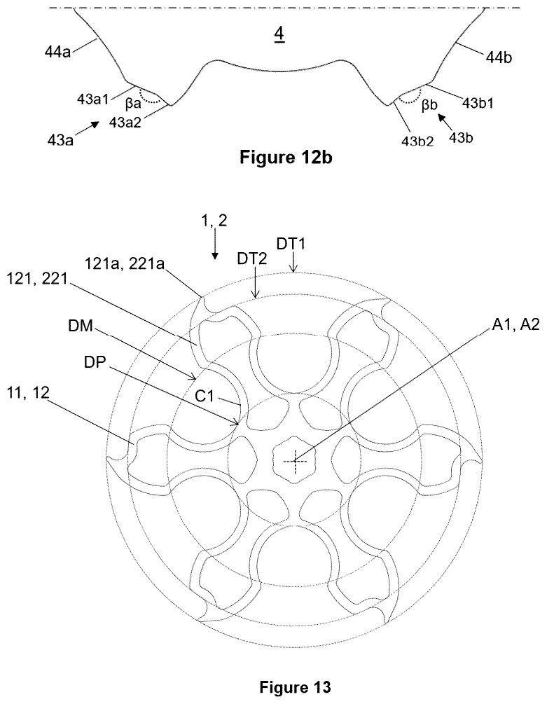

As will be explained below, the escapement device of FIGS. 1 to 10 is distinguished by a rocking angle β of the blocking mobile element greater than 50°, typically comprised between 55° and 60°, as clearly shown in FIG. 11. FIGS. 12 a, 12b detail the various geometric characteristics of the blocking mobile element 4. Particularly, the blocking mobile element 4 is equipped with a fork with horns 410, 420. Particularly, the fork 400 is provided with two first portions, called impulse portions 42a, 42b, disposed facing each other and arranged to transmit to the pin 511a of the balance 51, during an impulse step, at least part of the impulse received from the first escapement mobile element 1 or of the second escapement mobile element 2. The fork 400 comprises two second portions, called abutment portions 411b, 421b, disposed facing each other and each arranged by protruding from one of the first portions 42a, 42b. The abutment portions 411b, 421b are separated from or connected to the impulse portions 42a, 42b by connecting portions 411c, 421c.

These characteristics, particularly the abutment portions 411b, 421b and the connection portions 411c, 421c, are clearly visible in FIG. 12a, the large value of the tilt angle β makes the abutment portions 411b, 421b protruding, while the connection portions 411c, 421c, disposed between the abutment portions 411b, 421b and the first and second impulse surfaces or portions 42a, 42b, are specifically important in order to allow the pin 511a to pass during the release (see FIGS. 1 and 2, and FIGS. 6 and 7).

The horns 410, 420 also comprise distal walls 412, 422 in order to define abutment means B1, B2 at the junction of these walls and abutment portions 411, 421b, which are provided to possibly cooperate with the plate 511 in the event of an impact.

The blocking mobile element 4 also comprises releases 44a, 44b adjoining the first and second surface blocking portions 43a, 43b on the opposite side of the impulse input portions 41a, 41b. These releases are provided to prevent any interference between the escapement mobile elements 1, 2 and the blocking mobile element 4 outside the functional areas 41a, 41b, 43a, 43b, in particular when setting the time on the watch.

It can be noted in FIG. 12a that the first and second impulse input portions 41a, 41b are arranged between the first and second blocking surface portions 43a, 43b. Particularly, we can define on the blocking mobile element 4 represented in FIG. 12a:
a blocking sector angle θ1, defined by two straight lines each passing through the third axis of rotation A4 of the blocking mobile element 4 and intersecting respectively the first blocking surface portion 43a and the second blocking surface portion 43b,
an impulse sector angle θ2, defined by two straight lines, each passing through the third axis of rotation A4 of the blocking mobile element 4 and tangent respectively to the first impulse input surface 41a and to the second impulse input surface 41b (or passing through these first and second impulse input surfaces 41a, 41b), and the blocking sector angle θ1 is strictly greater than the impulse sector angle θ2.

FIGS. 1 to 10 illustrate the different steps of the method for maintaining the oscillations of the oscillator 5 by the escapement device, and which follow each other in the order of the figures in order to allow the proper functioning of the escapement device.

FIG. 1 illustrates a first step called first-rest step, in which a distal surface 121a of the first escapement mobile element 1 is in contact with a first blocking surface portion 43a of the blocking mobile element 4. During this step, the plate 511 of the balance 51 rotates initially clockwise and then counterclockwise under the effect of the elastic return of an elastic return member (typically a hairspring of a hairspring-balance).

FIG. 2 illustrates a first intermediate step called “unblocking” intermediate step, in which the pin 511a acts on a second impulse surface or portion 42b of a fork of the blocking mobile element 4 under the effect of the rotation of the balance 51, which now rotates counterclockwise. This intermediate step thus corresponds to a first step of releasing the balance 51 or the balance plate 511. During this step, the blocking mobile element 4 and the first escapement mobile element 1 rotate in the same pivot direction, here the clockwise direction. This allows the distal surface 121a to leave the first blocking surface portion 43a and to initiate the contact with a first impulse input portion 41a of the blocking mobile element 4.

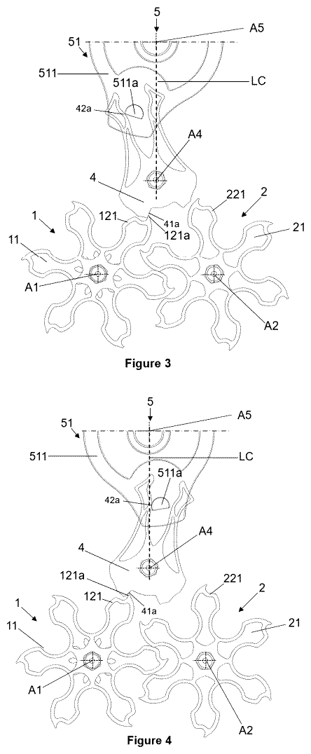

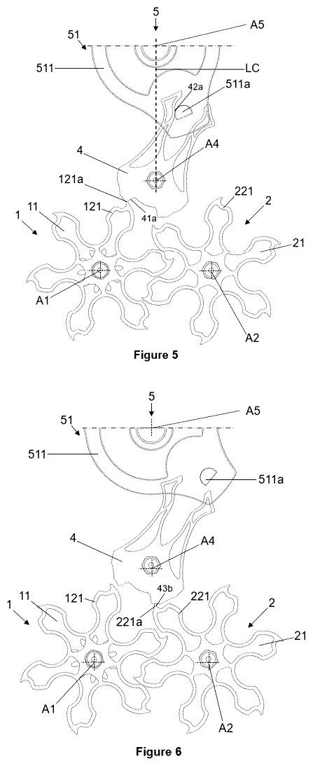

FIG. 3 illustrates a first phase of a second step called first-impulse step, in which the distal surface 121a is in contact and acts against the first impulse input portion 41a of the blocking mobile element 4, so that the impulse surface or portion 42a of the fork of the blocking mobile element 4 communicates an impulse to the pin 511a and so that the plate 511 of the balance thus continues its rotation counterclockwise. FIG. 4 illustrates a second phase of the second step called first-impulse step, in which the pin 511a passes the line of the centers LC. FIG. 5 illustrates a third phase of the second step called first-impulse step, in which the pin 511a is about to lose contact with the first impulse surface or portion 42a of the fork of the blocking mobile element 4. It can be noted that during the second step called first-impulse step, the blocking mobile element 4 and the first escapement mobile element 1 pivot along opposite directions of rotation.

FIG. 6 illustrates a third step called second-rest step, in which a distal surface 221a of the second escapement mobile element 2 is in contact with a second blocking surface portion 43b of the blocking mobile element 4. During this step, the plate 511 of the balance 51 rotates initially counterclockwise and then clockwise under the effect of the elastic return of the hairspring of the hairspring-balance.

FIG. 7 illustrates a second intermediate step called “unblocking” intermediate step, in which the pin 511a acts on the first impulse surface or portion 42a of the blocking mobile element 4 under the effect of the rotation of the balance 51 which now rotates clockwise. This intermediate step thus corresponds to a second step of releasing the balance 51 or the balance plate 511. During this step, the blocking mobile element 4 and the first escapement mobile element 1 rotate in the same pivot direction, here the counterclockwise direction. This allows the distal surface 221a to leave the second blocking surface portion 43b and to initiate the contact with a second impulse input portion 41b of the blocking mobile element 4.

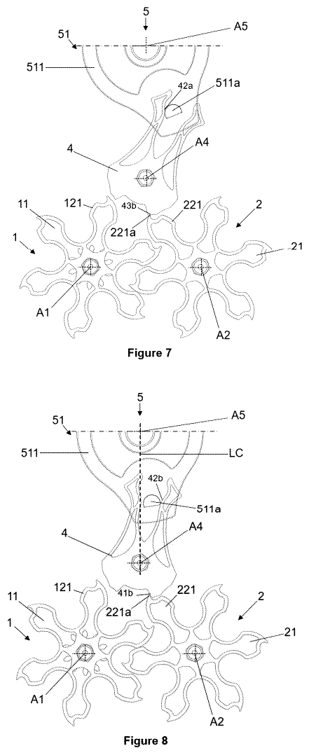

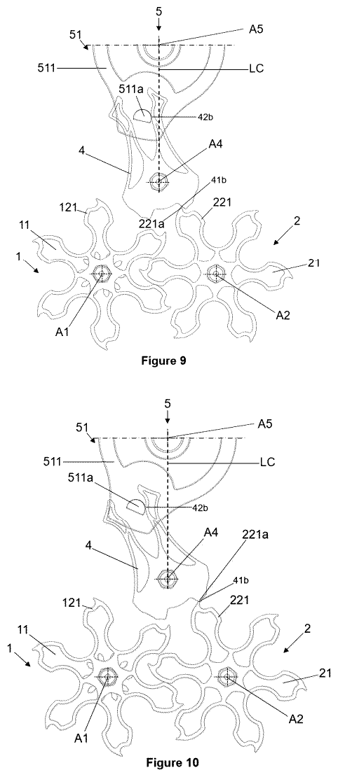

FIG. 8 illustrates the first phase of a fourth step called second-impulse step, in which the distal surface 221a acts against the second impulse input portion 41b of the blocking mobile element 4, so that the second impulse surface or portion 42b of the fork of the blocking mobile element 4 communicates an impulse to the pin 511a and so that the plate 511 of the balance thus continues its clockwise rotation. FIG. 9 illustrates the second phase of the fourth step called second-impulse step in which the pin 511a passes the line of the centers LC. FIG. 10 illustrates a third phase of the fourth step called second-impulse step, in which the pin 511a is about to lose contact with the second impulse surface or portion 42b of the fork of the blocking mobile element 4. It can be noted that during the fourth step called second-impulse step, the blocking mobile element 4 and the second escapement mobile element 2 pivot along opposite directions of rotation.

At the end of this fourth step, the escapement device returns to the configuration illustrated in FIG. 1. Thus, the operating method of the escapement device comprises a repetition of these different successive steps in order to maintain the oscillations of the hairspring-balance. This operating method is therefore a cyclic process that comprises a repetition of these different successive steps.

Thus, the operating method of the escapement device comprises, in this order:
a first step called first-rest step, in which a first escapement mobile element 1 is in cooperation with a blocking mobile element 4 in order to block their respective angular position;
a second step called first-impulse step, following the first step called first-rest step, in which the same first mobile element 1 is in cooperation with the blocking mobile element 4, so that this first mobile element 1 leads the blocking mobile element 4 along a predefined angular path;
a third step called second-rest step, following the second step called first-impulse step, in which a second escapement mobile element 2, kinematically connected to the first escapement mobile element 1, is in cooperation with the blocking mobile element 4 in order to block their respective angular position;
a fourth step called second-impulse step, following the third step called second-rest step, in which the same second escapement mobile element 2 is in cooperation with the blocking mobile element 4, so that this second mobile element 2 leads the blocking mobile element 4 along a predefined angular path.

This method comprises particularly:
a first intermediate step called “unblocking” intermediate step, interposed between the first step called first-rest step, and the second step called second-impulse step, in which the blocking mobile element 4 and the first escapement mobile element 1 rotate in the same direction.
a second intermediate step called “unblocking” intermediate step, interposed between the third step called second-rest step, and the fourth step called second-impulse step, in which the blocking mobile element 4 and the second escapement mobile element 2 rotate in the same direction.

In one alternative construction, it would be entirely conceivable to make the distal surfaces 121a, 221a cooperate with the portions P1 and/or P21, P22. Thus, these distal surfaces 121a, 221a would have a quadruple function: rest, unblocking, impulse and meshing.

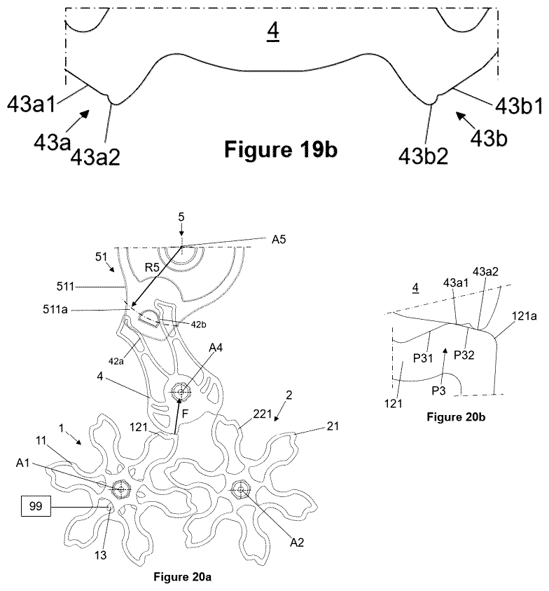

FIGS. 16 to 18 illustrate one variant of embodiment for the first escapement wheel 11 and the second escapement wheel 21 of the first and second escapement mobile elements, and FIGS. 19a, 19b illustrate one variant of embodiment for the blocking mobile element 4, to propose one alternative embodiment to the escapement device of FIGS. 1 to 10.

In the embodiment described above with reference to FIGS. 1 to 15, only the distal surface 121a, 221a of the distal portion P3 is functional.

In the alternative embodiment of FIGS. 16 to 26b, it is proposed to shape the distal portion P3 of each blocking tooth 121, 221 so as to bring the contact surfaces between the blocking mobile element 4 and an escapement mobile element 1 or 2 of the third axis of rotation A4 of the blocking mobile element 4 closer to each other, particularly during an unblocking step interposed between two successive rest and impulse steps.

Thus, for the same radius R5 (FIG. 11 or FIG. 20a), namely the same distance from the pin 511a with respect to the axis A5, for the same fork 410, 420 of a mobile element 4, and for the same pointing A1, A2, A4 of the mobile elements 1, 2 and 4, it is still possible to reduce the unblocking force necessary for the hairspring-balance.

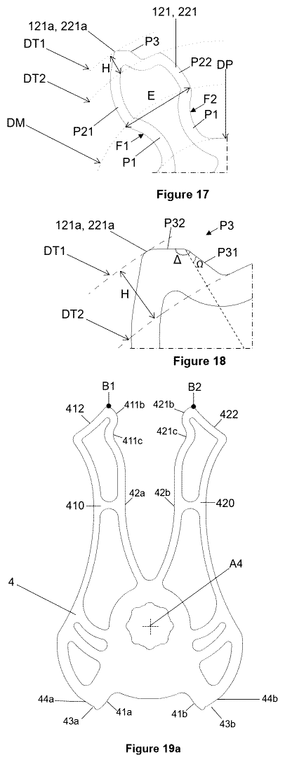

To do so, and as illustrated in FIGS. 17 and 18, each distal portion P3 is composed of a first portion P31 and of a second portion P32, both functional, namely cooperating with the blocking mobile element 4. The first portion P31 forms an angle Ω comprised between 15° and 25° with a straight line passing through the axis A1, A2 and the point of junction of the portions P31, P32, when this first portion P31 is viewed from the axis A1, A2. These portions P31 and P32 form a salient angle Δ, that is to say strictly less than 180°, typically comprised between 135° and 150°, when viewed from the axis A1, A2. In FIGS. 17 and 18, each first portion P31 and second portion P32 is planar, but curved surfaces are possible, in which case at least one tangent of each portion P31 and P32 forms a salient angle Δ, that is to say strictly less than 180°, typically comprised between 135° and 150°.

The portions P31 and P32 therefore form a V when viewed from the axis A1, A2, just as the portions 43a1, 43a2 and 43b1, 43b2 of the surface blocking portions 43a, 43b of the blocking mobile element 4 in FIGS. 12a, 12b when viewed from outside the blocking mobile element 4.

FIG. 16 illustrates an escapement wheel 11, 12 with such blocking teeth 121, 221, and FIGS. 17 and 18 illustrate the details of a particular blocking tooth. FIGS. 19a and 19b represent the blocking mobile element 4 cooperating with such wheels 11, 12.

FIGS. 20a and 20b illustrate an escapement device during a first step called first-rest step (equivalent to FIG. 1). The second portion P32 cooperates with the blocking mobile element 4 in two contact areas at surface portions 43a1, 43a2 and 43b1, 43b2 (visible and detailed in FIG. 19b). In this particular construction, the portions 43a1 and 43b1 are planar surfaces, while the portions 43a2, 43b2 are hemispherical and protrude from the portions 43a1 and 43b1, or at the very least, the portions 43a1 and 43b1 are separated from the portions 43a2, 43b2 by a recess or a recessed portion. These portions are shaped so that the resulting reaction force F between the mobile elements passes or substantially passes through the third axis of rotation A4 of the blocking mobile element 4.

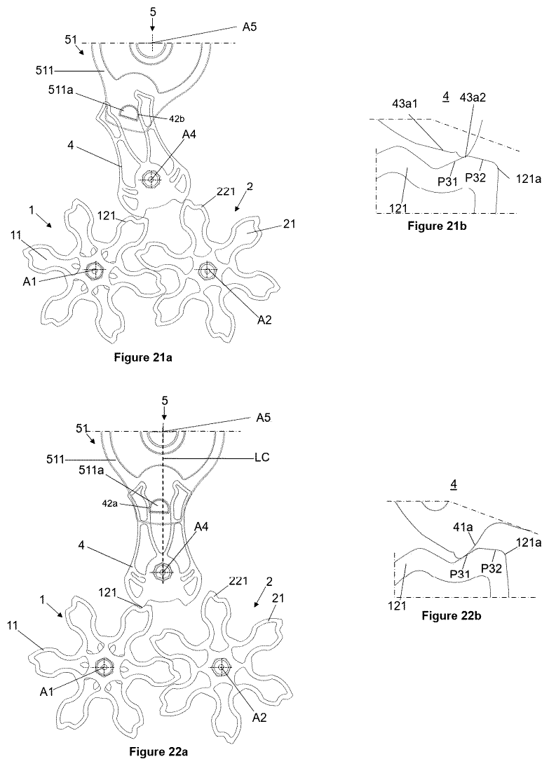

The first unblocking step (following the first step called first-rest step), initiated by the contact between the pin 511a and the portion 42b, induces the relative displacement of the portion P32 with respect to the portions 43a1 and 43a2 (always with a rotation in the same pivoting direction for the blocking mobile element 4 and the first escapement mobile element 1) until the configuration represented in FIGS. 21a, 21b which corresponds to the moment when the impulse step is initiated. In this configuration, the portion P31 comes in point-contact with the portion 43a2 to then cooperate with the impulse input portion 41a during the second step called first-impulse step.

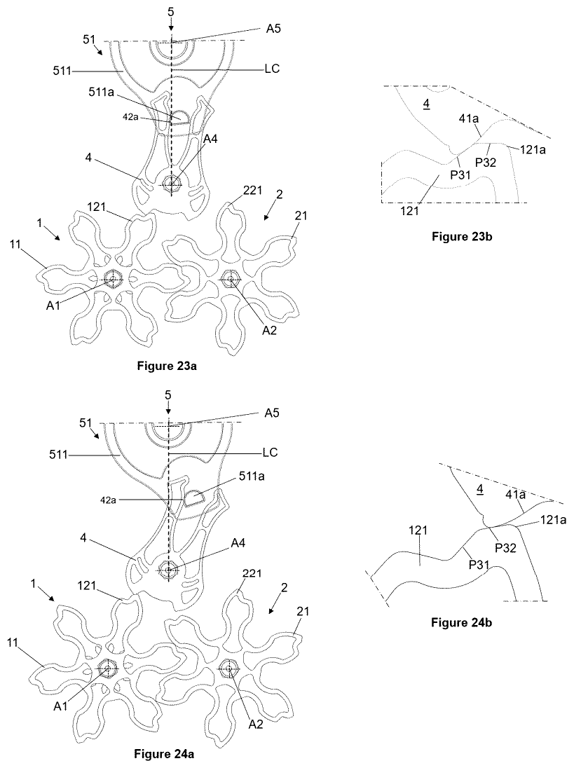

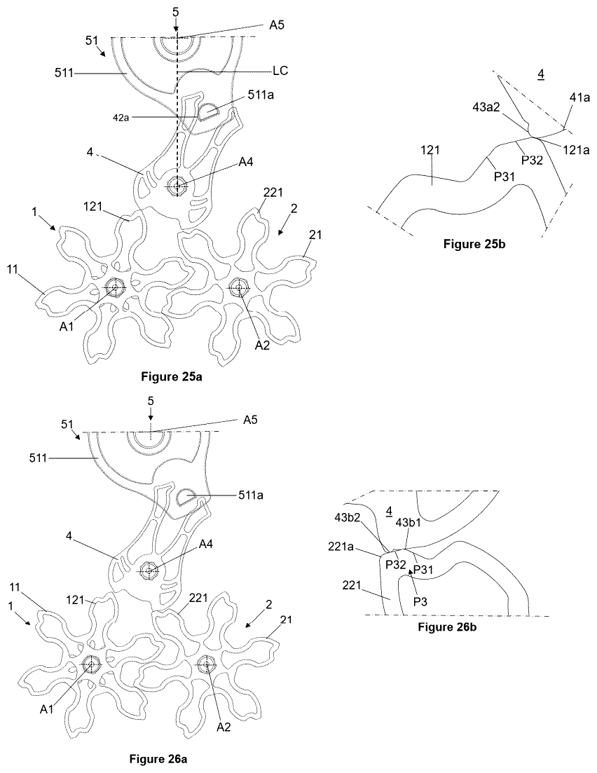

FIGS. 22a and 22b illustrate the contact between the portion 42a and the pin 511a upstream to the line of the centers LC. FIGS. 23a and 23b illustrate the contact between the portion 42a and the pin 511a downstream of the line of the center LC. In these representations, the first portion P31 cooperates with the portion 41a before the second portion P32 takes over (FIGS. 24a, 24b). The contact between the second portion P32 and the portion 41a continues until the distal portion 121a comes into contact with the end of the portion 41a, which here coincides with the end of the portion 43a2 (FIGS. 25a, 25b).

This is followed by a third step called second-rest step in which a blocking tooth 221 of the escapement wheel 21 cooperates with the portions 43b1, 43b2 of the blocking mobile element 4 (FIGS. 26a, 26b).

### INDUSTRIAL APPLICATION

An escapement device according to the present invention, and its manufacture, are capable of industrial application.

It will be understood that various modifications and/or improvements obvious to those skilled in the art can be made to the different embodiments of the invention described in the present description without departing from the framework of the invention.

Particularly, the escapement mobile elements can be “solid” mobile elements (without recesses) or hollowed mobile elements. The same applies to the blocking mobile element. Furthermore, the escapement mobile elements can be identical or different in their shapes (identical or different toothings, monolithic and/or composite structures, integrally formed and/or assemblies, identical or different numbers of teeth, can be provided), or in their materials.

1. An escapement device of a timepiece, comprising:
a first escapement mobile element arranged to be engaged with a drive gear train of the timepiece,
a second escapement mobile element engaged with the first escapement mobile element,
a blocking mobile element arranged to cooperate with an oscillator of the timepiece, wherein:
the first escapement mobile element comprises a first toothing comprising first blocking teeth,
the second escapement mobile element comprises a second toothing comprising second blocking teeth,
the first escapement mobile element is arranged to block the blocking mobile element in a first rest position with one of the first blocking teeth of the first toothing during a first step called first-rest step, followed by a second first step called first-impulse step,
the second escapement mobile element is arranged to block the blocking mobile element in a second rest position with one of the second blocking teeth of the second toothing during a third step called second-rest step, followed by a fourth step called second-impulse step, wherein:
during the second step called first-impulse step, the first escapement mobile element gives an impulse to the blocking mobile element, preferably with said one of the first blocking teeth, and drives directly one of the second blocking teeth of the second escapement mobile element with another of the first blocking teeth, and
during the fourth step called second-impulse step, the second escapement mobile element gives an impulse to the blocking mobile element, preferably with said one of the second blocking teeth, and is driven directly via another of the second blocking teeth by one of the first blocking teeth of the first escapement mobile element.

2. The escapement device according to claim 1, wherein the first escapement mobile element drives the second escapement mobile element exclusively with the first blocking teeth of the first toothing.

3. The escapement device according to claim 1, wherein the second escapement mobile element is driven by the first escapement mobile element exclusively via the second blocking teeth of the second toothing.

4. The escapement device according to claim 1, wherein the first escapement mobile element and/or the second escapement mobile element comprises or consists of a planar toothed wheel, preferably identical.

5. The escapement device according to claim 1, wherein:
during the second step called first-impulse step, the first escapement mobile element gives an impulse to the blocking mobile element with said one of the first blocking teeth, and drives directly one of the second blocking teeth of the second escapement mobile element with one of the first blocking teeth adjacent to said one of the first blocking teeth, and
during the fourth step called second-impulse step, the second escapement mobile element gives an impulse to the blocking mobile element with said one of the second blocking teeth, and is driven directly via one of the second blocking teeth adjacent to said one of the second blocking teeth.

6. The escapement device according to claim 1, wherein:
each first blocking tooth comprises, from a tooth root, a first concave portion, a second convex portion, and a distal surface,
each second blocking tooth comprises, from a tooth root, a first concave portion, a second convex portion, and a distal surface, wherein:
each distal surface of the first escapement mobile element and of the second escapement mobile element is arranged to be in contact with and block the blocking mobile element, during the first step called first-rest step or during the third step called second-rest step,
each second convex portion of the first escapement mobile element is arranged to be in contact with and drive a second convex portion of the second escapement mobile element, during the second step called first-impulse step or during the fourth step called second-impulse step, and
each first concave portion of the first escapement mobile element and of the second escapement mobile element is arranged to have a positive clearance or an absence of contact with each distal surface or with each second convex portion of the second escapement mobile element and of the first escapement mobile element, respectively.

7. The escapement device according to claim 6, wherein:
each first concave portion has a first tooth thickness E1,
each second convex portion has a second tooth thickness E2, and wherein: 1.5.E1<E2<2.5.E1.

8. The escapement device according to claim 6, wherein:
each distal surface of the first escapement mobile element and of the second escapement mobile element is formed by one end of each first blocking tooth and of each second blocking tooth, and/or
each distal surface of the first escapement mobile element and of the second escapement mobile element is formed by a rounded surface constituting a tooth tip, and/or
each distal surface of the first escapement mobile element and of the second escapement mobile element is arranged to cooperate exclusively with the blocking mobile element.

9. The escapement device according to claim 6, wherein:
each distal surface of the first escapement mobile element and of the second escapement mobile element is arranged to cooperate with the blocking mobile element and with the second escapement mobile element or the first escapement mobile element, respectively.

10. The escapement device according to claim 1, wherein:
each first blocking tooth comprises a first-tooth end,
each second blocking tooth comprises a second-tooth end, and wherein each first-tooth end and each second-tooth end comprises a first tooth flank surface and a second tooth flank surface, adjacent and each having at least a first tangent direction and at least a second tangent direction forming together a salient angle Δ.

11. The escapement device according to claim 10,
wherein the blocking mobile element comprises:
a first impulse input surface and a second impulse input surface,
a first blocking surface portion and a first blocking beak, preferably separated by a first recess, the first blocking beak being arranged between the first blocking surface portion and the first impulse input surface,
a second blocking surface portion and a second blocking beak, preferably separated by a second recess, the second blocking beak being arranged between the second blocking surface portion and the second impulse input surface,
wherein a second tooth flank surface of the first escapement mobile element is bearing on the first blocking surface portion and/or on the first blocking beak of the blocking mobile element during the first step called first-rest step, and a second tooth flank surface of the second escapement mobile element is bearing on the second blocking surface portion and/or on the second blocking beak of the blocking mobile element during the third step called second-rest step,
and wherein a first tooth flank surface of the first escapement mobile element is in contact with the first impulse input surface during the second step called first-impulse step, and a first tooth flank surface of the second escapement mobile element is in contact with the second impulse input surface during the fourth step called second-impulse step.

12. The escapement device according to claim 1, wherein the blocking mobile element is pivotally mounted and presents, between the first rest position and the second rest position, a rocking angle comprised between 50° and 70°, preferably between 55° and 65°, preferably between 57° and 63°.

13. The escapement device according to claim 1, wherein the first escapement mobile element comprises between four and eight teeth, preferably six teeth, and/or the second escapement mobile element comprises between four and eight teeth, preferably six teeth.

14. A timepiece, comprising at least one escapement device according to claim 1.
